(19) United States
(12) Patent Application Publication
(10) Pub. No.: US 2017/0015438 A1
(43) Pub. Date: Jan. 19, 2017

(54) WIRELESS PORTABLE LANDING ZONE

(71) Applicants: JONATHAN MATTHEW HARDING, Aliso Viejo, CA (US); TROY MERLE BROWN, Aliso Viejo, CA (US)

(72) Inventors: JONATHAN MATTHEW HARDING, Aliso Viejo, CA (US); TROY MERLE BROWN, Aliso Viejo, CA (US)

(21) Appl. No.: 14/803,079

(22) Filed: Jul. 19, 2015

(51) Int. Cl. B64F 1/00; G08G 5/02; B64F 1/20

(52) U.S. Cl. CPC B64F 1/00; B64F 1/20; G08G 5/025

(57) ABSTRACT

This disclosure relates generally to landing zone hardware used in UAV racing, recreational, and commercial applications; in particular, this disclosure relates to portable, foldable, and rollable landing zone hardware that includes embedded electronics and a cavity for insertion of smart devices for communicating status and/or condition information.

### CROSS REFERENCE TO RELATED APPLICATION(S)

This application claims the benefit of Provisional Patent Application No. 62/026,636, filed Jul. 19, 2014, in its entirety and is hereby incorporated by reference.

### FIELD OF THE INVENTION

The present invention generally relates to UAV racing, recreational, and commercial landing hardware; in particular, this disclosure relates to portable wireless landing zone hardware.

### BACKGROUND AND SUMMARY

Unmanned aerial vehicles inherently have stringent and specific landing requirements to assure accuracy and safety. Unmanned aerial vehicle racing also has inherent challenges related to landing zone identification, landing zone terrain, landing zone conditions, landing zone portability, start/finish syncronization, and identification of start/finish takeoff and landing zones. Therefore, there exists a need for a landing zone device that can provide portability, visual, logical, safety, and accuracy benefits. This landing pad device will provide for, but not limited to, Unmanned Aerial Systems , Unmanned Delivery Systems, and Unmanned Aerial Vehicles (referred to as UAVs, UASs, and Drones).

### DETAILED DESCRIPTION OF THE INVENTION

According to one aspect, this disclosure provides a WIRELESS PORTABLE LANDING ZONE configured in an easy to carry, folding and/or rolled pad. In some embodiments, the wireless landing pad device includes a cavity or pocket to enclose a mobile device (722), an IR sensor for detecting motion (726), an environment sensor for measuring temperature proximate the device (704), multi-colored LED lighting for various notifications and identification (700), rechargeable battery pack (716) and 110 v charger, unique identifier transponder (718), directional antenna (710), sounder (701), laser light safety curtain around perimeter (703), proximity sensor (723), wifi and/or bluetooth transceiver for networking (725), camera (719), accelerometer (708), barometric pressure sensor (706), bar code scanner (720), integrated GPS (713), smart device cavity (722), electromagnetic navigation tracking (715), laser tracking (711), folding capabilities for transport and storage (727), rolling capabilities for transport and storage (728), velcro straps for ease of carrying (729), and a transceiver (721) for sending wireless messages regarding sensed conditions and status.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a perspective and diagrammatic representation of an example wireless portable landing zone device according to an embodiment of the disclosure;

FIG. 2 is a side view of an example of a wireless portable landing zone device according to an embodiment of the disclosure;

FIG. 3 is a side view of an example of the rolled configuration of a wireless portable landing zone device according to an embodiment of the disclosure; and

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

This disclosure relates generally to a wireless portable landing zone 800 incorporated or embedded into a folding, rolled, fixed, or compact landing pad, to provide a clean surface to land a UAV vehicle upon, thus protecting the UAV from dirt and debris caused by propwash during landing, providing indication and/or syncronization of takeoff and landing of racing UAVs, and also providing notifications regarding usage of the UAV landing hardware and surrounding conditions. For example, the wireless landing device could notify the owner visually via integrated LEDs that the device is in use based on its embedded sensors. By way of example, the owner could be alerted as follows: when a UAV momentarily lands or takes off from the pad, when an object is present on the pad, when the landing pad itself has been moved, when an unsafe situation is detected, UAV mode status, etc. This information could be provided by embedded sensors in the pad and be used as input data to a mobile device placed in a designated cavity on the pad. In some embodiments, the wireless portable landing zone device could include a environment sensor, which could be used to measure landing environment near the landing pad. For example, the detected temperatures at the landing pad could be used as input data to a mobile device placed into the designated landing pad cavity for further UAV operations.

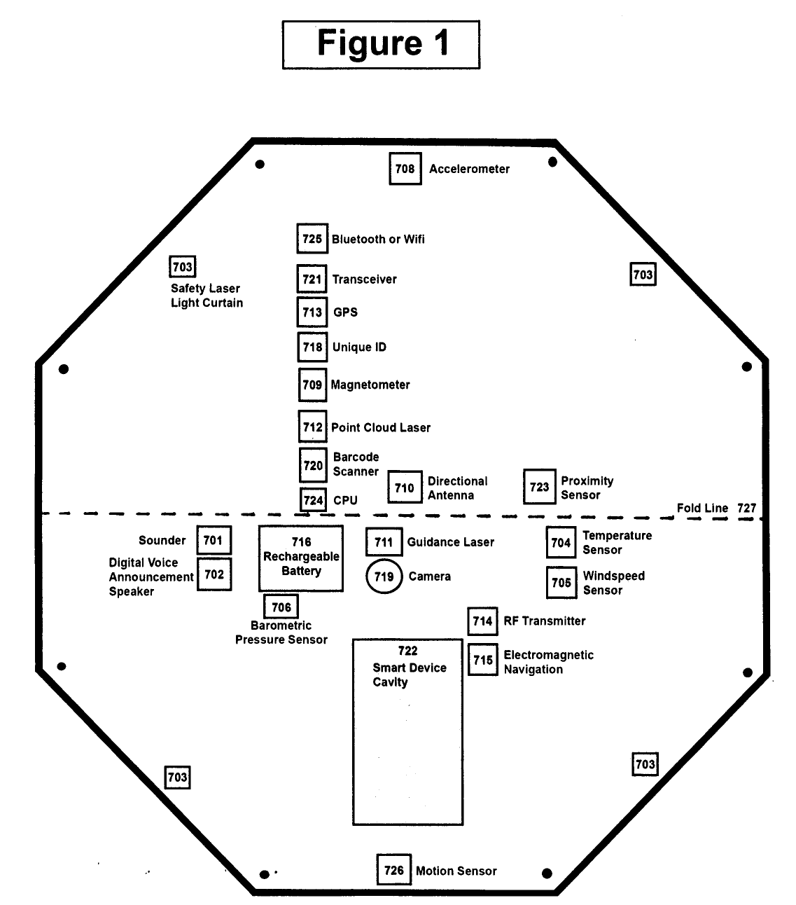

FIG. 1 shows an example wireless portable landing zone device 800 according to an embodiment of the disclosure. In this example, the wireless portable landing zone device 800 includes a transceiver/radio 721 for wirelessly transmitting (and optionally receiving) messages. For example, the transceiver/radio 721 could establish wireless communications with a hub 410, which could be a smartphone, gateway or other network device placed within the designated cavity of the landing pad. The transceiver/radio 721 could use any wireless protocol, including but not limited to Bluetooth, Bluetooth LE, protocols compatible with the IEEE 802.11 standard, such as using Wi-Fi, or the IEEE 802.15.4 standard, such as using Zigbee and Z-Wave, a cellular network, a wireless local area network, or other network protocol. Depending on the circumstances, this could be used to allow communications with a public network, such as the Internet or other cloud-based services and messaging. As shown, the transceiver/radio 721 is electronically controlled by a processor (“CPU”) 724. Various input data could be provided to the CPU 724, which could be transmitted by the transceiver/receiver 721. In this example, the wireless portable landing zone device 400 includes multiple sensors, such as the following: an accelerometer, for detecting movement and/or vibration; multicolored LEDs, for providing notifications to any person(s) within sight of the device; directional antenna, to provide landing assistance to any UAV; unique IDs, to provide landing pad identification for the UAV; audible sounders, to provide safety announcements in the vacinity of the landing pad; laser light curtains, to provide landing support and safety warnings around the perimeter of the pad ; pressure sensors, to provide object detection; a camera, to gather and analyze video to detect pad environment and/or safety information; bar code scanner, to provide identification of objects on the pad; laser tracking, to provide landing support to UAV; 110 v charger, to provide power to rechargeable battery pack; GPS, OCX GPS III, Bluetooth tracking, and Electromagnetic tracking, to provide tracking details that may be offered as inputs to a smart device; a on/off switch that can be switched mechanically or by wireless, to provide power to the wireless portable landing zone device 800. In some embodiments, the wireless portable landing zone device 800 could include a environment sensor 704, which could be used to measure an landing environment surrounding the wireless portable landing zone device 800.

As mentioned above, the wireless portable landing zone device 800 includes a wireless transceiver/radio 721, IR motion sensor (726), and accelerometer (708), embedded in the device that activates upon movement, vibration, or mechanical switch. Upon activation, the circuit and radio wake up from a low power state and transmits activity to a receiver, such as a hub. The transceiver/radio (721) is part of a circuit that determines notification status and can communicate multiple messages based upon mechanical, acceleration, and sensor information thresholds. As mentioned above, the wireless portable landing zone device 800 could include a environment sensor 704, such would allow the landing environment near the wireless portable landing zone device to be measured. For example, if the measured temperature or wind speed was outside of preset environment trip points, the transceiver/radio 721 could transmit the measured wind speed or temperature or trigger an alert that a trip point had been exceeded. The wireless portable landing zone device 800 may come in various styles, colors, and configurations. The wireless portable landing zone device 800 may also transmit over various wireless protocols to match existing receiving devices.

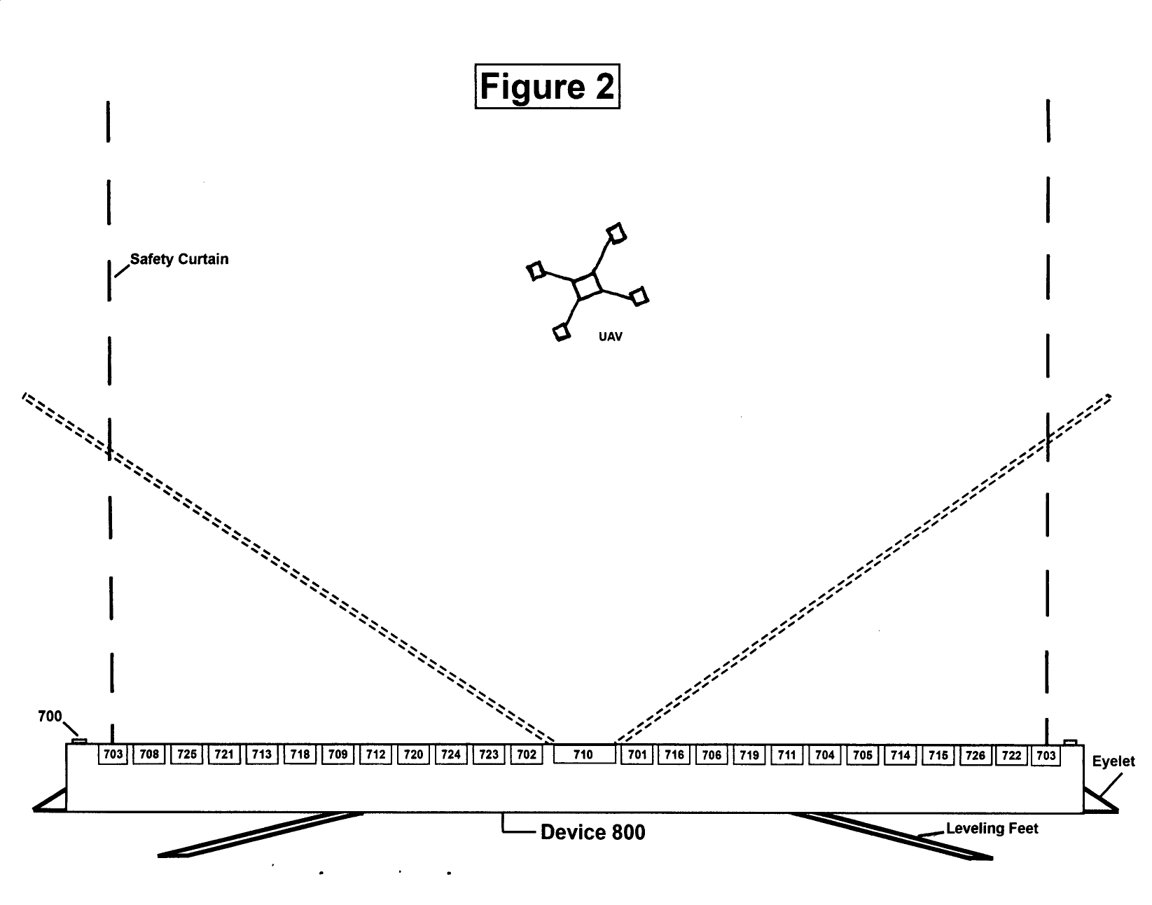

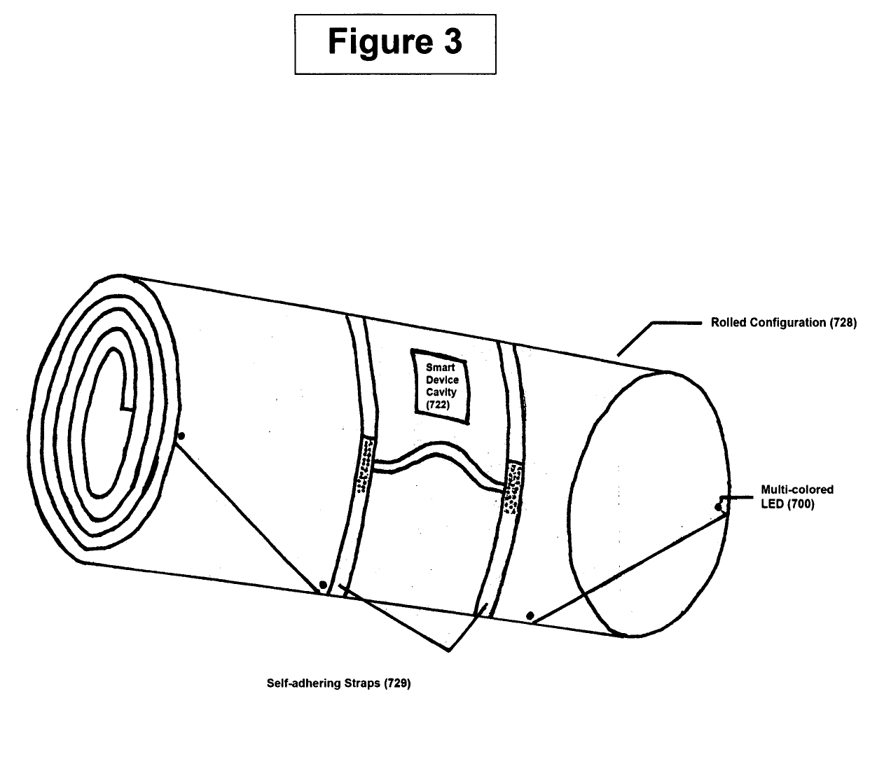

As mentioned above, the wireless portable landing zone device 800 includes a cavity for inserting a mobile device. FIG. 2 shows a side view of an embodiment in which the wireless portable landing zone device 400 is incorporated into a folding pad. FIG. 3 shows a side view of an embodiment in which the wireless portable landing zone device 800 is incorporated into a rolled pad.

FIG. 3 is a diagram showing the wireless portable landing zone device 800 incorporated into a folding pad, rolled pad, or fixed configuration using eyelets. The wireless portable landing zone device 800 embedded is configured to wirelessly communicate with the hub, which could be the owner's smartphone or other gateway or other network device placed in the designated cavity, which could further communicate with a public network if desired. Although one item for each type of hardware is shown in this figure for purposes of example, multiple combinations of the hardware with the wireless portable landing zone device 800 could be used depending on the circumstances. Likewise, not every type of hardware with a wireless portable landing zone 800 would necessarily be included in a device depending on the circumstances.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

1. A portable landing pad device comprising:
at least one interconnected pieces of material that may be folded into a geometric shape and configured to deploy as a landing zone by means of unfolding to full size.

2. A portable landing pad device comprising:
a single piece of material that may be rolled and configured to deploy as a landing zone by means of unrolling to full size.

3. The device of claim 1, wherein the landing pad may be anchored to the earth by means of at least one mechanical eyelet.

4. The device of claim 2, wherein the landing pad may be anchored to the earth by means of at least one mechanical eyelet.

5. The device of claim 1, wherein the landing pad is in a folded state, the pad is capable of being inserted into a customized bag, carrier or straps to be carried.

6. The device of claim 2, wherein the landing pad is in a rolled state, the pad is capable of being inserted into a customized bag, carrier or straps to be carried.

7. The device of claim 1, wherein the landing pad includes a designated cavity in which a mobile device may be placed.

8. The device of claim 2, wherein the landing pad includes a designated cavity in which a mobile device may be placed.

9. The device of claim 1, wherein the landing pad includes input/output circuits inside the device to;
provide safe operational and safety status including, but not limited to;
multicolor light emitting diodes (700)
sounder(s) (701)
digitized voice announcement speakers (702)
safety laser light curtain (703); and
detect landing environment including, but not limited to any combination of;
temperature sensor(s) (704)
wind speed sensor(s) (705)
barometric pressure sensor(s) (706)
accelerometer sensor(s) (708)
magnetometer sensor(s) (709); and
aid in navigation and landing including, but not limited to any combination of;
directional antenna array (710);
an array of antennas deployed on the landing pad to facilitate the UAV by means of RF signal strength (RSSI) and received data values received from associated flight transceivers that provide guidance to the proper landing location, speed, and distance; and
guidance laser (711);
a embedded laser that may be mechanically aimed at the intended incoming flight path which allows the UAV means to follow using on-board laser receiver; and
point cloud laser (712);
a embedded laser system that may be deployed to gather environment information on all objects surrounding landing pad, including incoming UAV; and
GPS receiver (713);
an embedded GPS satellite receiver that captures landing pad location for relay to incoming UAV; and
RF transmitter(714);
an embedded transmitter that broadcasts a unique or shared wireless ID that the incoming UAV may receive and use for rough landing pad location estimation; and
geomagnetic receiver(715);
an embedded receiver capable of detecting landing pad location by detecting landing pad geomagnetic environment; and
aid in normal operation, but not limited to any combination of;
110 v charger with rechargeable battery pack (716) unique ID (718);
an embedded identification ID that may be broadcast and shared by the device to aid in identification purposes; and
camera (719)
bar-code scanner (720)
wireless transceiver(721)
GPS receiver (713)

10. The device of claim 2, wherein the landing pad includes input/output circuits inside the device to;
provide safe operational and safety status including, but not limited to;
multicolor light emitting diodes (700)
sounder(s) (701)
digitized voice announcement speakers (702)
safety laser light curtain (703); and
detect landing environment including, but not limited to any combination of;
temperature sensor(s) (704)
wind speed sensor(s) (705)
barometric pressure sensor(s) (706)
accelerometer sensor(s) (708)
magnetometer sensor(s) (709); and
aid in navigation and landing including, but not limited to any combination of;
directional antenna array (710);
an array of antennas deployed on the landing pad to facilitate the UAV by means of RF signal strength (RSSI) and received data values received from associated flight transceivers that provide guidance to the proper landing location, speed, and distance; and
guidance laser (711);
a embedded laser that may be mechanically aimed at the intended incoming flight path which allows the UAV means to follow using on-board laser receiver; and
point cloud laser (712);
a embedded laser system that may be deployed to gather environment information on all objects surrounding landing pad, including incoming UAV; and
GPS receiver (713);
an embedded GPS satellite receiver that captures landing pad location for relay to incoming UAV; and
RF transmitter(714);
an embedded transmitter that broadcasts a unique or shared wireless ID that the incoming UAV may receive and use for rough landing pad location estimation; and
geomagnetic receiver(715);
an embedded receiver capable of detecting landing pad location by detecting landing pad geomagnetic environment; and
aid in normal operation, but not limited to any combination of;
110 v charger with rechargeable battery pack (716)
unique ID (718);
an embedded identification ID that may be broadcast and shared by the device to aid in identification purposes; and
camera (719)
bar-code scanner (720)
wireless transceiver(721)
GPS receiver (713)
